(19) United States
(12) Patent Application Publication
(10) Pub. No.: US 2009/0155615 A1
(43) Pub. Date: Jun. 18, 2009

(54) DESIGNED ORIENTATION FOR WELDED AUTOMOTIVE STRUCTURAL COMPONENTS MADE OF PRESS HARDENED STEEL

(75) Inventors: Chih-Chang Chen, Rochester Hills, MI (US); Sherald D. Ericson, Dryden, MI (US); Richard J. Ponke, Sterling Heights, MI (US); James W. Pavlovich, St. Clair Shores, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 11/958,629

(22) Filed: Dec. 18, 2007

(51) Int. Cl. B32B 3/12

(52) U.S. Cl. 428/593; 72/338

(57) ABSTRACT

The present invention provides an improved method of blanking and hot forming an elongated part from a coil of press hardened steel sheet stock, including the step of: cutting a blank from the coil of press hardened steel sheet stock such that the blank has a length that is greater than a width, and such that the length is substantially parallel to the rolling direction. Ideally, the blank is cut such that the length is parallel to the rolling direction within plus or minus ten degrees. The present invention also provides ultra high-strength metallic components, preferably automotive body shell parts, hot formed from coils of press hardened steel sheet stock. Each part has a body with a body length that is greater than a body width, and one or more weld joints. The body also has a material texture orientation that is substantially parallel to the body length.

### TECHNICAL FIELD

The present invention relates generally to metallic part blanks, and more particularly to elongated part blanks cut and hot formed into preselected configurations from press hardened steel sheet stock, and methods of blank cutting and forming the same.

### BACKGROUND OF THE INVENTION

Press hardened steel (PHS), also referred to in the art as “boron-steel” or “hot-stamped steel”, is one of the strongest steels used for automotive body structural applications—having tensile strength properties on the order of about 1400 mega-Pascal (MPa). With the increasing need to improve vehicle fuel efficiency and, at the same time, meet safety requirements, the use of PHS structural components is rapidly increasing. Consequently, such PHS components, which were initially common for door beams and bumpers, are now beginning to be used for many other structural components such as center pillars, hinge pillars, cross members, and roof rail reinforcements.

Such structural components made of PHS are often produced via a so-called “hot forming” or “hot stamping” process. As part of the production process, large slabs of steel undergo various metal working processes to obtain sheet stock, which is rolled into spools or coils. During hot forming, one or more blanks are cut from the metal coil. The cut blanks, which may or may not be preformed at ambient temperatures, are heated to elevated temperatures—e.g., about 900 degree Celsius (C), and thereafter transferred to water cooled dies. Subsequently, the red hot blanks are formed and quenched in the dies to derive the final shape, and realize the ultra high strength properties.

By and large, designing the layout pattern used to cut part blanks from metal sheet coils is solely dependent upon the nesting within the coil width limitation with respect to the blank dimension in order to minimize resultant scrap or to facilitate the stamping operation using the progressive blanking dies. For example, once the metal strip is uncoiled and straightened, it is cut into part blanks using, for example, a blanking press. Each blank is cut, in a manner often analogized to cookie cutting, into the general size (e.g., having the general boundaries) of the object to be manufactured. The part blanks may thereafter be exposed to other forming and treating processes, before the parts are assembled and combined into the shell body.

### SUMMARY OF THE INVENTION

The present invention provides an improved method of producing hot formed elongated structural components made of press hardened steel part blanks from metal sheet stock. The methods described herein offer ultra high-strength metallic components with improved structural resilience and resistance to undesirable fracture along weld joints. The present invention eliminates the need to resort to fracture mitigation methods, including, but not limited to, removing spot welds in critical regions, use of adhesives, and widened flange sizes.

In a first preferred embodiment of the present invention, an improved method of producing hot formed structural components from a coil of press hardened steel sheet stock is provided. The coil of metal sheet stock has a rolling direction. The method includes the step of: cutting a blank from the coil of press hardened steel sheet stock such that the blank has a length that is greater than a width, and such that the length is substantially parallel to the rolling direction. The blank should be cut such that the length is parallel to the rolling direction within plus or minus ten degrees. The “rolling direction” of the metal sheet stock will generally be understood as the direction in which the material is elongated as the material thickness is reduced during either a hot rolling or cold rolling process.

The method of producing hot formed structural components also includes the steps of: increasing the temperature of the blank by passing the blank through a furnace; forming the blank into a predetermined structural component with a water cooled press such that a length of the predetermined structural component is substantially parallel to a material texture orientation thereof, and reducing the temperature of the predetermined structural component by quenching the same. Thereafter, one or more weld joints are then made into the predetermined structural component during the body manufacturing. The predetermined structural component may be, for example, a center pillar, hinge pillar, door beam, cross bar, or roof rail reinforcement of a vehicle body structure. An additional step, which may be included prior to increasing the temperature of the blank, is to form the blank into a pre-formed shape.

It is desirable that the step of cutting the blank from the coil of press hardened steel sheet stock includes: feeding a flat portion of the press hardened steel sheet stock into a blanking press that comprises an upper die portion operatively opposing a lower die portion. The upper and lower die portions are oriented relative to the flat portion of the press hardened steel sheet stock such that the length of the cutting contour is substantially parallel to the rolling direction. Thereafter, the upper die portion cooperates with the lower die portion so as to cut the blank from the flat portion of the press hardened steel sheet stock. Alternatively, if the blanks are produced by alternative methods, such as laser cutting, instead of a blanking press, the same concept still holds true that the length of the cut blanks is substantially parallel to the rolling direction and/or the material texture orientation.

According to another preferred embodiment of the present invention, a hot formed, elongated metallic component is provided. The component has a body with a body length that is greater than a body width. One or more weld joints are made in the hot formed, elongated metallic component. The body of the metallic component has a material texture orientation that is substantially parallel to the body length. In other words, the body is fabricated from a metal sheet stock coil having a rolling direction, wherein the coil rolling direction is substantially parallel to the body length. The metal sheet stock consists of press hardened steel. The high-strength metallic component is preferably a constituent part of an automotive body structure, which may include, for example, a center pillar, hinge pillar, door beam, cross bar, and roof rail reinforcement.

The above features and advantages, and other features and advantages, of the present invention are readily apparent from the following detailed description of the preferred embodiments and best modes for carrying out the present invention when taken in connection with the accompanying drawings and appended claims.

### BRIEF DESCRIPTION OF THE DRAWINGS

FIG. 1 is a schematic illustration of a plurality of automotive part blanks being cut and hot formed from a coil of press hardened steel sheet stock in accordance with a preferred embodiment of the present invention;

FIG. 1A is an enlarged schematic illustration of a portion of the metal sheet stock of FIG. 1 provided to depict the orientation of the material texture (and rolling direction) relative to the metal sheet stock coil in accordance with the present invention;

FIG. 2 is a perspective view of an exemplary automobile body structural component hot formed in accordance to the methods of the present invention, depicting the component after undergoing significant bending deformation;

FIG. 2A is an enlarged perspective view of a portion of the component of FIG. 2 provided to depict the orientation of the component body length relative to the rolling direction and resulting improved mechanical characteristics; and

FIG. 2B is a cross-sectional view taken along line 1-1 of FIG. 2.

### DESCRIPTION OF THE PREFERRED EMBODIMENTS

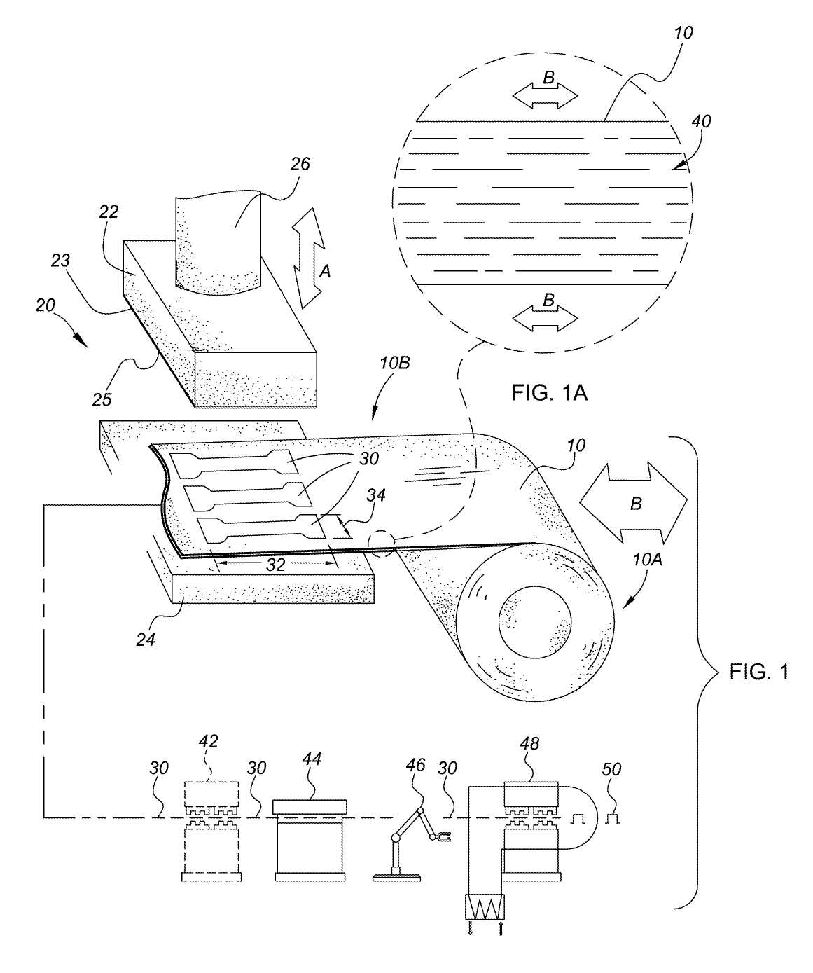

Referring to the figures, wherein like reference numbers refer to like components throughout the several views, there is shown in FIG. 1 an improved process or method of cutting and hot forming part blanks from a coil of metal sheet stock in accordance with the present invention. FIG. 1 is provided merely for explanatory purposes, representing the method and resulting metallic components of the present invention in a simplified illustration. The constituent members are purely exemplary, and the dimensions thereof exaggerated for clarity and for a better understanding of the method of use. As such, the present invention is by no means limited to the particular structure or layout presented therein. To that extent, the present invention can be used to form part blanks of varying sizes and geometries without departing from the intended scope of the present invention.

Indicated at 10 in FIG. 1 is a coil of metal sheet stock, preferably consisting of press hardened steel (PHS). The coil of metal sheet stock 10 is shown with a coiled or rolled portion, indicated generally at 10A, and an uncoiled sheet portion, indicated generally at 10B. FIG. 1 also shows a blanking device or apparatus for cutting part blanks from the coil of metal sheet stock 10, represented herein in a purely exemplary embodiment as a blanking press indicated generally by reference numeral 20.

The blanking press 20 is shown in FIG. 1 in a first position corresponding to the beginning of a cutting operation, which is preferably continuously repeated in accordance with the method of the present invention, as represented by arrow A. As the coiled portion 10A of the metal sheet stock 10 is unrolled, the sheet portion 10B is fed or passed into the blanking press 20.

The blanking press 20 is defined herein by a punch portion 22 with an upper die portion 23 extending generally orthogonally from a lower surface thereof. The punch and upper die portions 22, 23 are positioned adjacent to and operatively aligned with a lower die portion 24. The upper and lower die portions 23, 24 cooperate to define a cutting contour 25 that is generally coextensive in shape and geometry as each part blank 30. The punch portion 22 has a generally rectangular shape, and is joined or coupled to a ramming member 26, which is operable to produce the force necessary to cut the part blanks 30 from the metal sheet stock 10. In FIG. 1, the upper and lower die portions 23, 24 are shown cutting a plurality of part blanks 30 from the flat portion 10B of the metal sheet stock 10. The configuration of the blanking press 20 may be varied without departing from the scope of the claimed invention. In a similar respect, the blanks 30 may be produced by alternative cutting methods. For example, the blanks 30 may be produced via laser cutting (not shown) instead of a blanking press (such as press 20 of FIG. 1) without departing from the scope of the invention claimed herein so long as the length of the cut blanks 30 is substantially parallel to the rolling direction B and/or the material texture orientation 40.

Each of the part blanks 30 has a body length 32 that is greater than a body width 34. The part blanks 30 are formed such that the body length 32 is substantially parallel to a rolling direction B of the metal sheet stock 10. The rolling direction B of the metal sheet stock 10 will generally be understood as the direction in which the metal sheet stock 10 elongated as the material thickness is reduced during a prior hot rolling or cold rolling process. According to a preferred embodiment, the blank 30 is cut such that the length 32 is parallel to the rolling direction B within plus or minus ten degrees. In so doing, the body length 32 of each part blank 30 is substantially parallel to a material texture orientation, indicated generally at 40 in FIG. 1A in a simplified and purely symbolic illustration.

Once the blanking operation is complete—i.e., using blanking press 20, the flat blanks 30 are thereafter subjected to additional hot-forming operations. In instances where the predetermined final shape of the component to be manufactured is relatively complex, the part blank 30 may undergo a pre-forming operation to supplement subsequent forming operations. This optional step is represented herein by the pre-forming press 42, shown with hidden lines in FIG. 1 subsequent to the blanking operation described above.

Thereafter, the temperature of the blank 30 is increased. By way of example, each blank 30 is passed through a furnace 44 (which may include a protective atmosphere to avoid high temperature oxidation of a bare press hardened steel part) and soaked at approximately 900 degrees Celsius (C). The blank 30 is then transferred from the furnace 44 (e.g., via a robotic cell 46 or any other functional means) to be formed into a predetermined final shape. More specifically, each hot blank 30 is transferred from the furnace 44 to a water cooled press 48 in the open air/atmosphere. The blank 30 is then “hot formed” and rapidly quenched into a final predetermined structural component 50, promptly reducing the temperature of the blank 30 to realize certain ultra-high strength characteristics. Finally, if not aluminized or coated, the blank 30 can also be shotpeened or sand blasted (not shown herein) to remove the oxide scale resulting from the hot forming process, and trimmed to remove excess material.

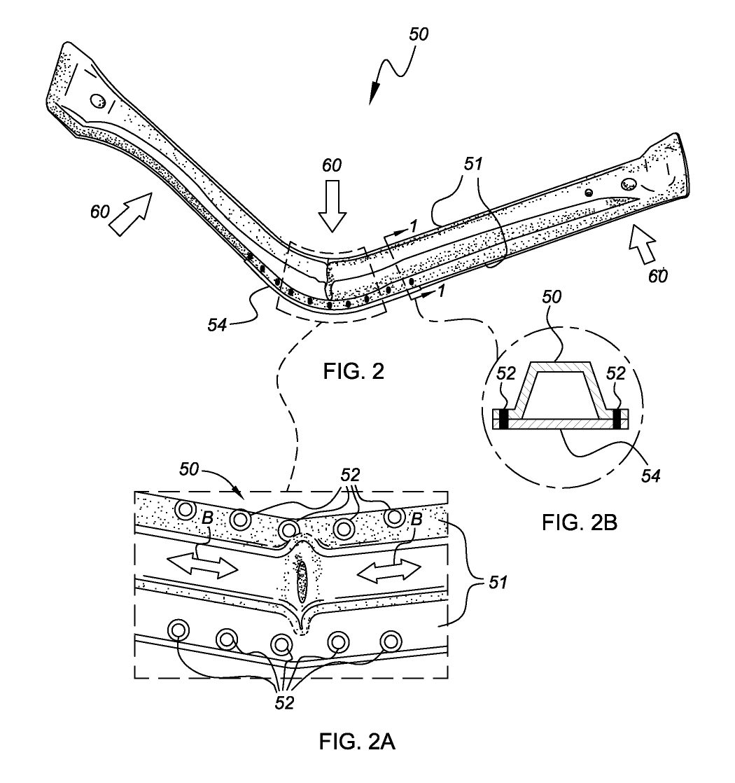

A perspective view of an exemplary automobile body structure component formed in accordance to the method of the present invention is provided in FIG. 2. The component can be any constituent part of the vehicle body structure, such as, but not limited to, a center pillar, hinge pillar, cross member, and roof rail reinforcement, all of which are collectively represented herein by a door beam, identified generally at 50. The component 50 is a post-processed form of the part blank 30 formed according the method of FIG. 1. In other words, once the part blank 30 is cut from the coil of metal sheet stock 10, the part blank 30 is subject to subsequent forming and finishing processes, as described hereinabove. The embodiment of FIG. 2 also includes a plurality of welds or weld joints 52 (e.g., through resistance spot welding) oriented along an outer periphery (or flange portion) 51 thereof, as best seen in FIGS. 2A and 2B. As best seen in FIG. 2B, the weld joints 52 join the component 50 to a support plate 54. Even though the component 50 is hot formed press hardened steel, the support plate 54 can consist of any common automotive structural steels fabricated from any known process.

The operations which are used to form metal sheet stock, such as hot rolling, cold rolling, and annealing operations, may cause crystallographic anisotropy. During these operations, there is a tendency for elongated inclusions or material texture to develop following the rolling direction. Such elongated inclusions and crystallographic anisotropy can lead to anisotropy in the stress-strain relationships in the metal strip or sheet of steel at such ultra high strength levels. When a hot-formed part, such as component 50, is welded into a sub-assembly, and is subjected to bending load, represented herein by moment arm force vectors 60 of FIG. 2, resultant stresses tend to concentrate around the weld joints 52. Rupture may occur if the weld joints 52 are over stressed. Propagation of the rupture into the base metal may readily occur following the elongated inclusions or material texture if the steel rolling direction B is transverse to the length of the component 50, such as length 32 of FIG. 1. Consequently, metallic components made according to the method of the present invention, such as component 50, offer improved structural resilience and resistance to undesirable fracture. The present invention eliminates the need to resort to fracture mitigation methods, including, but not limited to, removing spot welds in critical regions, use of adhesives, and widened flange sizes.

While the best modes for carrying out the present invention have been described in detail herein, those familiar with the art to which this invention pertains will recognize various alternative designs and embodiments for practicing the invention within the scope of the appended claims.

1. A method of producing hot formed structural components from a coil of press hardened steel sheet stock having a rolling direction, comprising:
cutting a blank from the coil of press hardened steel sheet stock such that said blank has a length that is greater than a width, and such that said length is substantially parallel to the rolling direction.

2. The method of claim 1, wherein said cutting said blank is such that said length is parallel to the rolling direction within plus or minus ten degrees.

3. The method of claim 2, further comprising:
increasing the temperature of said blank by passing said blank through a furnace;
forming said blank into a predetermined structural component with a water cooled press such that a length of said predetermined structural component is substantially parallel to a material texture orientation thereof, and
reducing the temperature of said predetermined structural component by quenching the same.

4. The method of claim 3, further comprising:
forming said blank into a pre-formed shape prior to said increasing the temperature of said blank.

5. The method of claim 3, further comprising:
forming at least one weld joint in said predetermined structural component after said reducing the temperature of said predetermined structural component.

6. The method of claim 5, wherein said cutting said blank includes:
feeding a flat portion of the press hardened steel sheet stock into a blanking press including an upper die portion operatively opposing a lower die portion, said upper and lower die portions defining a cutting contour having said length and said width;
orienting said upper and lower die portions relative to said flat portion such that said length of said cutting contour is substantially parallel to the rolling direction; and
causing said upper die portion to cooperate with said lower die portion so as to cut said blank from said flat portion of the coil of press hardened steel sheet stock.

7. The method of claim 6, wherein said predetermined structural component is one of a center pillar, hinge pillar, door beam, cross bar, and roof rail reinforcement.

8. A method of producing hot formed structural components from a coil of press hardened steel sheet stock having a predetermined rolling direction, the method comprising:
cutting a blank from a flat portion of the coil of press hardened steel sheet stock such that said blank has a length that is greater than a width, and such that said length is substantially parallel to the predetermined rolling direction;
increasing the temperature of said blank by passing said blank through a furnace;
forming said blank into a predetermined structural component with a water cooled press such that a length of said predetermined structural component is substantially parallel to a material texture orientation thereof, and
reducing the temperature of said predetermined structural component by quenching the same; and
forming at least one weld joint in said predetermined structural component;
wherein said cutting said blank is such that said length is parallel to the rolling direction within plus or minus ten degrees.

9. The method of claim 8, further comprising:
forming said blank into a pre-formed shape prior to said increasing the temperature of said blank.

10. A hot formed elongated metallic component, comprising:
a body having a material texture orientation and a body length that is greater than a body width; and
at least one weld joint;
wherein said material texture orientation is substantially parallel to said body length.

11. The metallic component of claim 10, wherein said body is fabricated from a metal sheet stock coil having a rolling direction, wherein said coil rolling direction is substantially parallel to said body length.

12. The metallic component of claim 11, wherein said metal sheet stock consists essentially of press hardened steel.

13. The metallic component of claim 12, wherein said body is one of a center pillar, hinge pillar, door beam, cross bar, and roof rail reinforcement.
